(19) United States
(12) Patent Application Publication
(10) Pub. No.: US 2026/0011337 A1
(43) Pub. Date: Jan. 8, 2026

(54) NOISE REDUCTION IN AUDIO MIXING SYSTEMS INCLUDING A BEAMFORMER

(71) Applicant: Synaptics Incorporated, San Jose, CA (US)

(72) Inventors: John Usher, Berlin (DE); Tim Trini, Bubenreuth (DE); Dirk Posselt, Nuremberg (DE)

(73) Assignee: Synaptics Incorporated, San Jose, CA (US)

(21) Appl. No.: 18/762,455

(22) Filed: Jul. 2, 2024

(51) Int. Cl. G10L 21/0232; G10L 21/0216; G10L 21/034; G10L 21/0364; G10L 25/18; G10L 25/30

(52) U.S. Cl. CPC G10L 21/0232; G10L 21/034; G10L 21/0364; G10L 25/18; G10L 25/30; G10L 2021/02166

(57) ABSTRACT

This disclosure provides methods, devices, and systems for audio signal mixing. The present implementations more specifically relate to mixing audio signals from a microphone array by performing fixed beamforming to generate beams, reducing noise on the beams, and mixing the beams to generate a final audio signal for playback. In some aspects, an audio mixing system includes a fixed beamformer to generate beams from audio signals from a microphone array and noise reduction units (NRUs) to reduce a noise component of each audio beam. The system also includes logic to calculate a signal characteristic of each reduced noise audio beam to determine, based on the signal characteristics, the reduced noise audio beams that include a speech component. The logic also generates a gain for each audio beam based on the selection, with the gains used in beam mixing. In some aspects, the NRU includes a neural network noise reduction unit.

### TECHNICAL FIELD

The present implementations relate generally to audio signal mixing, and specifically to mixing audio beams from an audio beamformer to reduce noise and beam selection lag in generating a mixed audio signal for playback.

### BACKGROUND OF RELATED ART

Microphone arrays include a plurality of microphones in fixed positions to each other to receive audio from a plurality of directions of the surrounding environment. The microphones are configured to convert sound waves from the surrounding environment into audio signals that can be transmitted to audio processing devices or over a communications channel to an end device (such as a speaker). The audio signals may include a speech component (representing audio originating from a near-end user) and a noise component (representing ambient audio from the background environment). An audio mixer mixes the audio signals to generate a single audio signal for playback.

The audio signals may be processed to reduce the noise component (thus enhancing the speech component) of the audio signals before mixing (which is referred to as noise reduction). As a result of the positioning of the microphones in the microphone array, a subset of the microphones may be better positioned to receive audio from the environment than the other microphones. For example, one or more microphones may be shadowed, or have more shadows, as compared to other microphones of the microphone array. In a specific example, a housing for the microphones may obstruct a direct traversal of sound from a user to a microphone, such that the microphone is shadowed with reference to the user. In particular, a microphone oriented towards a near-end user (or otherwise has a clear line of traversal) of the microphone array may be better suited to receive audio from the near-end user (which includes a speech component) as compared to the other microphones of the microphone array. There is a need to better process audio signals from such a microphone array, and in particular to improve noise reduction for mixing and playback.

### SUMMARY

This Summary is provided to introduce in a simplified form a selection of concepts that are further described below in the Detailed Description. This Summary is not intended to identify key features or essential features of the claimed subject matter, nor is it intended to limit the scope of the claimed subject matter.

One innovative aspect of the subject matter of this disclosure can be implemented in a method of audio mixing. The method includes receiving a plurality of audio beams. The audio beams are generated from a plurality of audio signals from a microphone array. The method also includes, for each audio beam of the plurality of audio beams, generating a reduced noise audio beam from the audio beam by reducing a noise component of the audio beam and calculating a signal characteristic of the reduced noise audio beam. The method further includes determining, based on the plurality of signal characteristics of the plurality of reduced noise audio beams, one or more reduced noise audio beams of the plurality of reduced noise audio beams that include a speech component. The method also includes generating, for each audio beam of the plurality of audio beams, a gain for the audio beam based on the determination.

Another innovative aspect of the subject matter of this disclosure can be implemented in an audio mixing system, including a processing system and a memory. The memory stores instructions that, when executed by the processing system, cause the audio mixing system to perform operations including receiving a plurality of audio beams. The audio beams are generated from a plurality of audio signals from a microphone array. The operations also include, for each audio beam of the plurality of audio beams, generating a reduced noise audio beam from the audio beam by reducing a noise component of the audio beam and calculating a signal characteristic of the reduced noise audio beam. The operations further include determining, based on the plurality of signal characteristics of the plurality of reduced noise audio beams, one or more reduced noise audio beams of the plurality of reduced noise audio beams that include a speech component. The operations also include generating, for each audio beam of the plurality of audio beams, a gain for the audio beam based on the determination.

### BRIEF DESCRIPTION OF THE DRAWINGS

The present implementations are illustrated by way of example and are not intended to be limited by the figures of the accompanying drawings.

FIG. 1 shows an example environment including a microphone array.

FIG. 2 shows a block diagram of an example audio mixing system, according to some implementations.

FIG. 3 shows a block diagram of an example system with at least some components of an audio mixing system implemented in software, according to some implementations.

FIG. 4 shows an illustrative flowchart depicting an example operation for generating gains for audio mixing, according to some implementations.

FIG. 5 shows an illustrative flowchart depicting an example operation for calculating a signal-to-noise ratio for an audio beam, according to some implementations.

FIG. 6 shows an illustrative flowchart depicting an example operation for generating a gain for an audio beam based on a time measurement indicating when a corresponding reduced noise audio beam includes a speech component, according to some implementations.

FIG. 7 shows an illustrative flowchart depicting an example operation for generating a gain for each audio beam, according to some implementations.

FIG. 8 shows an illustrative flowchart depicting an example operation for mixing the audio beams and generating an output audio signal, according to some implementations.

FIG. 9 shows an illustrative flowchart depicting an example operation for generating an audio beam, according to some implementations.

FIG. 10 shows an illustrative flowchart depicting an example operation for generating a control signal based on a direction of arrival (DOA), according to some implementations.

### DETAILED DESCRIPTION

In the following description, numerous specific details are set forth such as examples of specific components, circuits, and processes to provide a thorough understanding of the present disclosure. The term “coupled” as used herein means connected directly to or connected through one or more intervening components or circuits. The terms “electronic system,” “electronic device,” “system,” and “device” may be used interchangeably to refer to any system capable of electronically processing information. Also, in the following description and for purposes of explanation, specific nomenclature is set forth to provide a thorough understanding of the aspects of the disclosure. However, it will be apparent to one skilled in the art that these specific details may not be required to practice the example embodiments. In other instances, well-known circuits and devices are shown in block diagram form to avoid obscuring the present disclosure. Some portions of the detailed descriptions which follow are presented in terms of procedures, logic blocks, processing, and other symbolic representations of operations on data bits within a computer memory.

These descriptions and representations are the means used by those skilled in the data processing arts to most effectively convey the substance of their work to others skilled in the art. In the present disclosure, a procedure, logic block, process, or the like, is conceived to be a self-consistent sequence of steps or instructions leading to a desired result. The steps are those requiring physical manipulations of physical quantities. Usually, although not necessarily, these quantities take the form of electrical or magnetic signals capable of being stored, transferred, combined, compared, and otherwise manipulated in a computer system. It should be borne in mind, however, that all of these and similar terms are to be associated with the appropriate physical quantities and are merely convenient labels applied to these quantities.

Unless specifically stated otherwise as apparent from the following discussions, it is appreciated that throughout the present application, discussions utilizing the terms such as “accessing,” “receiving,” “sending,” “using,” “selecting,” “determining,” “normalizing,” “multiplying,” “averaging,” “monitoring,” “comparing,” “applying,” “updating,” “measuring,” “deriving” or the like, refer to the actions and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

In the figures, a single block may be described as performing a function or functions; however, in actual practice, the function or functions performed by that block may be performed in a single component or across multiple components, and/or may be performed using hardware, using software, or using a combination of hardware and software. To clearly illustrate this interchangeability of hardware and software, various illustrative components, blocks, modules, circuits, and steps have been described below generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Also, the example input devices may include components other than those shown, including well-known components such as a processor, memory and the like.

The techniques described herein may be implemented in hardware, software, firmware, or any combination thereof, unless specifically described as being implemented in a specific manner. Any features described as modules or components may also be implemented together in an integrated logic device or separately as discrete but interoperable logic devices. If implemented in software, the techniques may be realized at least in part by a non-transitory processor-readable storage medium including instructions that, when executed, performs one or more of the methods described above. The non-transitory processor-readable data storage medium may form part of a computer program product, which may include packaging materials.

The non-transitory processor-readable storage medium may comprise random access memory (RAM) such as synchronous dynamic random-access memory (SDRAM), read only memory (ROM), non-volatile random access memory (NVRAM), electrically erasable programmable read-only memory (EEPROM), FLASH memory, other known storage media, and the like. The techniques additionally, or alternatively, may be realized at least in part by a processor-readable communication medium that carries or communicates code in the form of instructions or data structures and that can be accessed, read, and/or executed by a computer or other processor.

The various illustrative logical blocks, modules, circuits, and instructions described in connection with the embodiments disclosed herein may be executed by one or more processors (or a processing system). The term “processor,” as used herein may refer to any general-purpose processor, special-purpose processor, conventional processor, controller, microcontroller, and/or state machine capable of executing scripts or instructions of one or more software programs stored in memory.

Implementations are described herein of mixing audio signals to improve noise reduction. In particular, an audio mixing system as described herein is configured to generate a mixed audio signal for playback from audio beams (beams) from a beamformer to focus on a speech component (such as speech from a near-end user close to a microphone array) in the beams while reducing a noise component (which may include both diffuse noise and acute noises) in the beams. The implementations improve noise reduction and reduce beam selection lag in generating the mixed audio signal for playback as compared to typical audio mixing systems.

As described above, microphone arrays include a plurality of microphones in fixed positions to each other to receive audio from a plurality of directions of the surrounding environment. Different example microphone arrays may include two microphones oriented along a line segment, three microphones oriented in a triangle configuration, four microphones oriented in a rectangle (such as square) or diamond configuration, or five or more microphones oriented in a circular (or other suitable shape) configuration.

Each microphone receives sound waves (referred to as audio herein) from the surrounding environment, and the microphone converts the received audio into an audio signal (such as a transducer to generate an electrical signal from the vibration of physical sound waves received at a cone, with the electrical signal potentially being converted to a digital signal by an analog to digital converter (ADC)). Audio that is received at a microphone may include a desired audio component and an undesired audio component. For example, if the audio to be captured by a microphone is speech from one or more people talking near the microphone (e.g., near-end users), the desired audio component may be a speech component from the one or more people. However, the audio may also include noises from chairs shuffling, cars driving, keyboard typing, doors slamming, coughing, or other noises that are unwanted (which are referred to as a noise component).

A microphone array may be used with beamforming techniques to improve the output audio signal generated after processing, with the microphone array being used to form a spatial filter to isolate or amplify an audio signal or signal component from a specific direction from the microphone array. As used herein, an audio beam or beam may refer to the audio signal generated from audio signals from a microphone array to represent the audio received from a direction at the microphone array (with each audio signal corresponding to an audio received at a microphone of the microphone array). As such, a beam may be generated by a beamformer from one or more audio signals from one or more microphones of the microphone array. Generating one or more beams is referred to herein as beamforming.

Typical audio beamformers (also referred to herein as beamformers) are adaptive beamformers that require a feedback mechanism to perform beamforming. In particular, a feedback system is used to calculate weights to be applied to the audio signals from the microphone array to generate beams. An example adaptive beamformer typically used is a general sidelobe canceler (GSC), which can be updated using the linearly constrained minimum variance (LCMV), the Frost algorithm, or the minimum variance distortion-less response (MVDR) algorithm.

A beamformer is included in an audio mixing system, which generates an output audio signal for playback from the plurality of audio signals from the microphone array. In addition to beamforming, the audio mixing system (such as the beamformer) may be tasked with reducing noise (i.e., the noise component) of the audio for the output audio signal from the audio mixing system. To note, each audio signal from the microphone array may include a speech component and a noise component (as the audio received at the microphone may include a speech component and a noise component). Since each audio signal may include a speech component and a noise component, a beam generated from one or more audio signals may also include a speech component and a noise component.

Adaptive beamformers can adaptively reduce diffuse noise concurrently with receiving signals from a desired direction in the environment. For example, an adaptive beamformer with a microphone array in a conference room may be capable of reducing noise from a constant hum of a projector or an air conditioning system while generating beams from a plurality of audio signals from a microphone array in order to generate an output audio signal from the beams.

However, adaptive beamformers are capable of concurrently performing beamforming and reducing noise only when a noise component of the audio received at the microphone array is diffuse noise. In real world applications, though, various acute noises exist in an environment. For example, for a microphone array on a table in a conference room, a person may repeatedly tap the table with a pen or pencil. In addition, a chair may fall or be moved, a door may close, a shade may be drawn, a person may type on a keyboard, background conversations not of interest may occur (such as by the door to the conference room), audio may reverberate in the room, or a variety of other acute noises may exist such that the noise component of the audio received at the microphone array is not exclusively diffuse noise. Typical adaptive beamformers are unable to handle such acute noises to effectively reduce noise. As such, a typical adaptive beamformer may be unable to effectively reduce a noise component of an audio signal in order to isolate a speech component of interest. In addition, with adaptive beamformers requiring feedback systems, a typical adaptive beamformer may generate unwanted artifacts in beams as a result of the feedback including the acute noises, thus reducing the signal quality of the output audio signal from the audio mixing system.

Another type of beamformer is a fixed beamformer. In contrast to an adaptive beamformer that requires a feedback system in order to perform beamforming, a typical fixed beamformer includes fixed weights to be applied to the audio signals in order to generate the beams. The fixed weights are predefined based on the fixed positions of the microphones of a microphone array and the aspects of the environment, with the microphone being fixed in place in a specific location in the environment (such as a microphone array fixed in a same location in a dedicated conference room).

Fixed beamformers use long finite impulse response (FIR) filters to be able to generate narrow beams that represent a specific direction from the microphone array or location in the environment including the microphone array and thus can focus on wanted audio from a near-end source (such as a speech component from a near-end user) based on the known directions of the beams, which increases the direct-to-reverberant energy of the audio in the beams generated from the audio signals. In addition to a fixed beamformer, an audio mixing system may include a beam steering system (referred to herein as a beam select logic unit (BSLU)) to select active beams from the beams generated by the beamformer. For example, a BSLU may calculate a signal-to-noise ratio (SNR) of each beam from the beamformer and select one or more beams with a high SNR to indicate which beams are active and thus on which to focus for mixing.

For a typical audio mixing system that includes a beamformer and a BSLU and is to focus on the speech component of the audio signals to generate a desired overall output audio signal, an active beam is to include a speech component, with the speech of the speech component to be captured in the output audio signal for playback. The audio mixing system may thus focus on combining such active beams. To identify active beams that include a speech component, the audio mixing system (such as the BSLU) may include or be coupled to a voice activity detector (VAD) to detect the presence of speech in each beam generated by the beamformer. As such, the BSLU may identify a beam as active if the VAD indicates that speech is detected in the beam (which may be in addition to the SNR of the beam being greater than a threshold), and the audio mixing system may focus on mixing those active beams.

One problem with conventional VADs of typical fixed beamformers is that conventional VAD algorithms implemented by a VAD can cause the VAD to confuse speech with non-speech sounds, such as keyboard taps or other sounds that mimic the rhythm and sounds of speech. As a result, the VAD can provide false signal and noise level estimates that negatively impact generation of the overall output audio signal. As such, conventional signal level estimators that rely on conventional VADs may produce estimates of signal and noise levels that are of a reduced quality, with those estimates then used by the BSLU or to otherwise control the audio mixing system to generate a reduced quality output audio signal. In addition, VADs introduce a lag in generating the mixed audio signal for playback, as processing the beams using a VAD requires additional time.

As noted above, an audio mixing system may include a BSLU to select active beams. The BSLU may select different beams as audio changes in the environment. As such, beam mixing to generate the output audio signal for playback includes switching the beams to be mixed. Switching beams for mixing may be performed by adjusting gains applied to the beams in order to emphasize some beams and deemphasize others in the output audio signal. The switching of beams is desired to be gradual (such as a gradual gain change) to reduce rapid fluctuations of sounds in the output audio signal (which can sound jarring and undesirable). The rate of change of switching (referred to as an adaptation rate herein) may be based on time-smoothing a signal level estimate or other smoothing of gain change time constants. If time-smoothing a signal level estimate is performed, time-smoothing may be from a hysteresis system to reduce the rapid fluctuations in the gain.

To note, the adaptation rate influences sound quality, as a longer adaptation rate will smoothen transitions between beams. However, longer adaptation rates increase the likelihood of missing initial speech sounds of a person in a beam in the output audio signal. As such, a long adaptation rate can cause an overall audio signal output to not include the first phonemes at the start of words as switching between beams is occurring. In addition, in cases of sudden onsets of noise sources that have a similar angle to an active beam, updates to an SNR estimate for the beam may be delayed as a result of the adaptation rate, which may impact beam selection such that the beginning of the noise can be heard in the overall output audio signal (thus degrading the quality of the overall output audio signal).

To attempt to mitigate the problems of missing phonemes and the inclusion of the beginning of noises in the overall output audio signal from a conventional audio mixing system using a beamformer, conventional beamforming techniques may include look-ahead processing. However, look-ahead processing requires that the beams be delayed in order to process the audio signals before generating the overall output audio signal from the processed audio signals. Delays caused by look-ahead processing has an undesirable impact on audio mixing systems for which the time to generate the output audio signal for playback is of the essence (such as for real-time applications, such as for voice telecommunication systems).

Therefore, there is a need for improvement to current audio mixing systems that use beamforming techniques to reduce audio throughput latency (i.e., the amount of time needed to generate the overall output audio signal) while also improving audio quality (i.e., better reducing noise components and thus focusing on speech components).

As described herein, various aspects of audio signal mixing are described, and, more particularly, enhancements to an audio mixing system are described to improve beam selection lag and audio quality of the output audio signal generated by the audio mixing system. In some aspects, a processing system to perform audio mixing is configured to reduce a noise component of each beam and then calculate a signal characteristic (such as SNR or a signal level) directly from the reduced noise audio beam. The signal characteristics are then used to generate the gains to be used for mixing the audio beams. Such implementations do not require a VAD, look-ahead processing, or other processing means that introduces lengthy delays and causes errors in the output audio signal from the audio mixing system, thus improving the performance of the audio mixing system.

In some aspects, a noise reduction unit (NRU) that reduces a noise component of an audio beam includes a neural network NRU (NNNRU). In some aspects, the signal characteristic calculated from the reduced noise audio beam includes an SNR or a signal level, which is used to identify whether the beam is active, which indicates that the audio beam includes a speech component. As noted above, identifying that a beam is active may also be referred to as selecting the beam. In some aspects, the gains to be used for beam mixing to generate the final output audio signal (also referred to herein as a mixed audio signal) are based on which beams are selected.

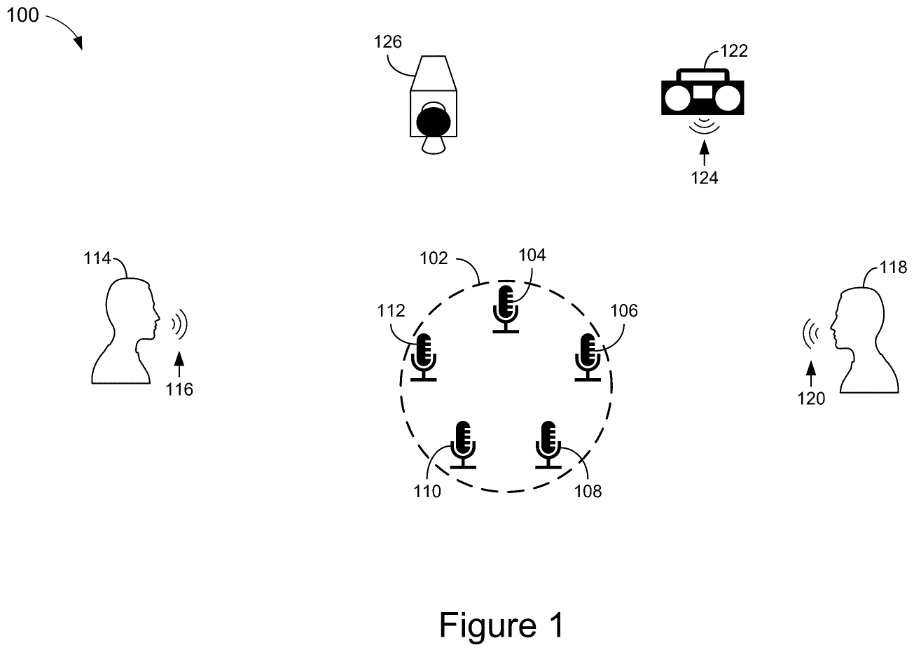

Applications of particular interest for the audio mixing system as described herein include real-time applications in which it is desired to generate the mixed audio signal from beams generated from the audio signals received from the microphone array as soon as possible while also performing noise reduction to a desired level. An example real-time application includes teleconferencing. For teleconferencing, one or more near-end users speak towards a microphone array, with an audio mixing system that includes a fixed beamformer processing the audio signals from the microphones of the microphone array to generate the mixed audio signal that is transmitted to a far-end device that plays the mixed audio signal via a speaker to one or more far-end users. The environment setup of the microphone array and users as well as other potential devices are described with reference to FIG. 1. To note, while the examples herein describe an audio mixing system with reference to a microphone array used in a teleconference application, the audio mixing system and processes described herein apply to other applications, such as live streaming of a concert or other live event or live audio monitoring by personnel for security systems. To note, the audio mixing system and processes may also be used in less time sensitive applications to improve noise reduction.

FIG. 1 shows an example environment 100 including a microphone array 102. The environment 100 may be a teleconference room, in which near-end user 114 speaks (depicted as audio waves 116) and near-end user 118 speaks (depicted as audio waves 120). Two users are depicted for simplicity, but any number of users may be in the environment 100.

The microphone array 102 is depicted as including five microphones 104-112 oriented in a circular configuration. While five microphones and a circular orientation is depicted for simplicity, the microphone array may include any number of microphones (greater than one) positioned in any suitable orientation (such as a square, rectangle, diamond, or a more random orientation). Each microphone 104-112 may be any suitable microphone to receive audio and convert the audio to an audio signal. As such, microphone 104 may generate a first audio signal from audio received at microphone 104, microphone 106 may generate a second audio signal from audio received at microphone 106, microphone 108 may generate a third audio signal from audio received at microphone 108, microphone 110 may generate a fourth audio signal from audio received at microphone 110, and microphone 112 may generate a fifth audio signal from audio received at microphone 112.

Some microphones may be better positioned to receive audio from a user than other microphones of the microphone array. For example, microphone 112 is positioned closer to user 114 and is able to better receive the audio waves 116 before the waves diffuse in the environment 100. Similarly, microphone 106 is positioned closer to user 118 and is able to better receive the audio waves 120 before the waves diffuse in the environment 100.

Noise may also be received by the microphones 104-112. For example, a loudspeaker 122 may generate sound waves 124 that are to be considered noise and are received by the microphones 104-112. Other examples include keyboard clicks if user 114 or 118 is typing during a teleconference call, a door moving, a window opening or closing, or any other sounds not desired to be included in the mixed audio signal mixed from the audio signals generated by the microphones 104-112.

In some implementations, a teleconference call or other types of audio presentations (such as concerts or broadcasts) may include video. As such, the environment 100 may include one or more video cameras, which are depicted for simplicity as camera 126. For example, the camera 126 may be used during a video teleconference call to focus either on user 114 or 118 based on which one is currently speaking. As such, the camera 126 may be configured to move (such as rotate left/right and up/down) and/or zoom in/out to capture different portions of the environment 100.

With the microphone array 102 to generate five audio signals, an audio mixing system is to obtain the audio signals, process the audio signals, and mix the processed audio signals to generate a mixed audio signal that is to be played at the far-end of the teleconference system (such as in a different conference room). For an audio mixing system that includes a beamformer, the beamformer generates beams from the audio signals from the microphone array, and the audio mixing system mixes the beams to generate the mixed audio signal for playback.

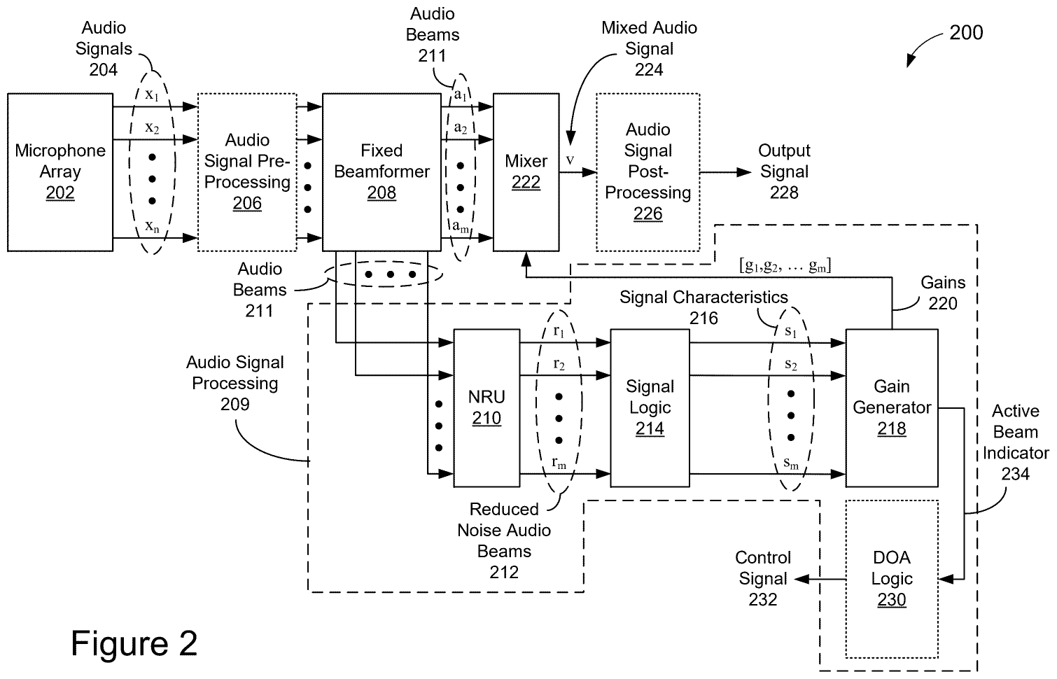

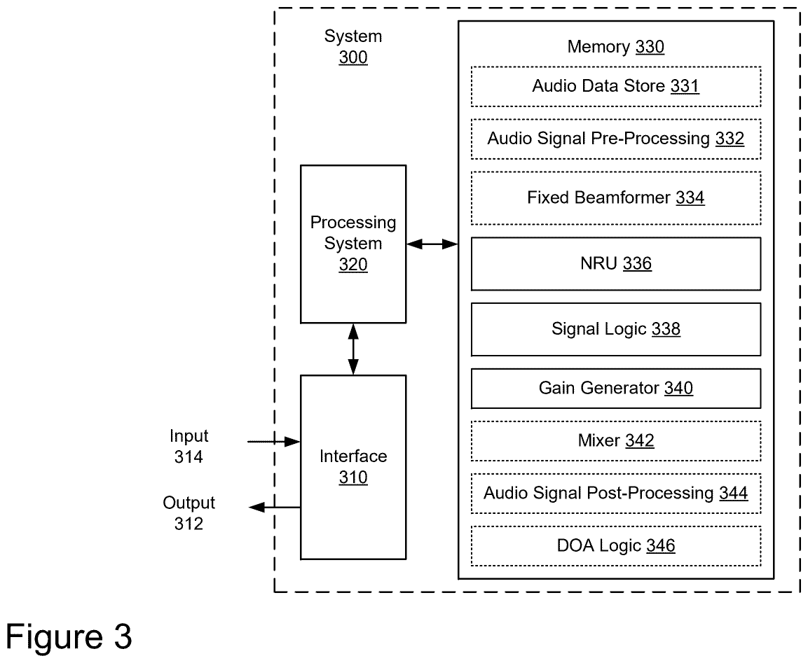

FIG. 2 shows a block diagram of an example audio mixing system 200, according to some implementations. The audio mixing system 200 generates an output signal 228 (which is the final mixed audio signal for playback) from audio received at a microphone array 202 based on audio signal processing 209 not found in typical audio mixing systems. The audio signal processing 209 may be implemented in software that is stored in a memory and executed by a processing system, such as depicted in FIG. 3 and described below. The audio mixing system 200 includes or is coupled to a microphone array 202. The audio mixing system 200 also includes a beamformer (such as a fixed beamformer 208), audio signal processing 209, and a mixer 222. In some implementations, the audio mixing system 200 may also include an audio signal pre-processing 206 and an audio signal post-processing 226. Similar to the audio signal processing 209, the components 206, 208, 222, and 226 of the audio mixing system 200 may be implemented in software and executed by a processing system. In some other implementations, components of the audio mixing system 200 may be implemented in hardware or a combination of hardware and software.

The microphone array 202 includes n microphones (with n being an integer greater than 1) whose received audio are converted into audio signals 204 (which include audio signals x₁ to xₙ). In particular, a first microphone receives audio from an environment (such as the environment 100) from which the audio signal x₁ of the audio signals 204 is generated, a second microphone receives audio from the environment (such as the environment 100) from which the audio signal x₂ of the audio signals 204 is generated, up to an nth microphone receiving audio from the environment (such as the environment 100) from which the audio signal xₙ of the audio signals 204 is generated. For example, for audio signal x₁, a first cone may receive the audio, a first transducer may convert the vibrations of the cone into an electrical signal, and a first analog to digital converter (ADC) may convert the electrical signal into a digital signal that is the audio signal x₁.

In some implementations, the microphone array 202 (such as for a teleconferencing system) may include five to eight microphones arranged in a circle with a diameter of approximately 10 centimeters (cm). In some other implementations, any number of microphones (greater than one) in any suitable orientation can be incorporated into a desktop telephone, a computer monitor, a laptop, or a mobile computing device. For example, a desktop telephone may include a line array of 4 or 5 microphones spaced approximately 1.5 cm from each other, a microphone on the rear of the telephone, and a microphone on the top of the telephone. To note, each microphone may be an omni-directional microphone to receive audio from all directions in the environment.

If the audio mixing system 200 includes an audio signal pre-processing 206, the audio signal pre-processing 206 includes one or more filters or modules applied to the audio signals 204 to pre-condition the audio signals 204 for beamforming. Example filters or modules to pre-process the audio signals 204 include an automatic gain control unit (GCU), a signal filter (such as a signal equalization system), an acoustic echo canceling system, a dereverberation system, a signal encoder, and a sample rate converter. Processing an audio signal 204 by the audio signal pre-processing 206 may include applying one or more of the above example filters or modules to filter, encode, and/or convert the sample rate for the audio signal 204 to be in a condition and format to be received by the fixed beamformer 208.

The fixed beamformer 208 is a multi-input multi-output (MIMO) beamformer configured to receive n audio signals from the microphone array 202 and generate m audio beams 211 for an integer m greater than 1. As depicted, the m audio beams 211 include audio beams a₁ to aₘ. In the example depicted in FIG. 2, the fixed beamformer 208 receives the n processed audio signals from the audio signal pre-processing 206 and generates the m audio beams 211 that are provided to the mixer 222 and the audio signal processing 209. The m beams represent m different directions of audio in the environment received at the microphone array 202. In some implementations, the number of beams is from 4 to 6, thus representing the audio received at the microphone array 202 from 4 to 6 different directions in the environment.

The fixed beamformer 208 that generates m beams 211 includes n finite impulse response (FIR) filters to process the n audio signals 204, with audio signal 204 processed by a unique FIR filter. In some implementations, an FIR filter is of a length such that the impulse response length of the FIR filter is 16 milliseconds (ms), such as based on 512 filter taps of the FIR filter operating at a frequency of 32 kHz for the audio signal. However, any suitable impulse response (IR) length other than 16 ms may also be used. To generate an output beam, the fixed beamformer 208 combines the n outputs of the n FIR filters to generate the audio beam. For each audio beam, the beamformer may use different FIR filter coefficients. For example, a first set of FIR filter coefficients are used to generate a first audio beam, a second set of FIR filter coefficients are used to generate a second audio beam, up to a set m of FIR filter coefficients being used to generate an audio beam m. As such, the fixed beamformer 208 includes an m-by-n-by-p set of FIR filter coefficients, with p being the number of filter taps per FIR filter.

The m-by-n-by-p set of FIR filter coefficients are predefined based on acoustic characteristics of the environment and the device including the microphone array. For example, to generate the m-by-n-by-p set of FIR filter coefficients, m target directions in the environment to be represented by the m beams may be defined, and the filter impulse response from each target direction to each microphone of the microphone array 202 may be determined. The impulse response may be determined through either a theoretical model based on the configuration of the microphone array and the environment or in-situ measurements at the microphones of the microphone array 202. For example, measurements of anechoic impulse responses of the microphone array 202 may be performed in an anechoic chamber. In other examples, measurements may be performed in any environment in which the microphone array may be used or in which acoustic characteristics of the device may be determined, such as a conference room, a movie theatre, an automobile, or an outdoor space.

The m-by-n-by-p set of FIR filter coefficients may be represented in a matrix. To generate the matrix, in-situ measurements of impulse responses may be made (such as in an anechoic chamber) for a plurality of different directions of a source sound to each microphone. In some implementations, a sound source is placed at many different positions around the microphone array to measure the different impulse responses based on location with reference to the microphone array. For example, an impulse response may be measured for a sound source moved five degrees around the microphone for each measurement so that 72 measurements are generated per microphone. A matrix of measured impulse response coefficient arrays is generated from the measurements, and the generated matrix is numerically inverted (such as using Least Mean Squares plus regularization) to represent the m-by-n-by-p sets of filter coefficients to be used.

The audio signal processing 209 generates gains 220 (which includes a gain for each beam 211, depicted as gains g₁ through gₘ) to be used for mixing the audio beams 211 by the mixer 222. The mixer 222 mixes the audio beams 211 to generate the mixed audio signal 224 (also depicted as mixed audio signal v). For example, the mixer 222 multiplies each audio beam 211 by its corresponding gain 220 to generate gain corrected audio beams, and then the mixer 222 sums the gain corrected audio beams to generate the mixed audio signal v. In some implementations, the mixed audio signal v is ready for playback without additional processing. In such implementations, the mixed audio signal 224 may be the same as the output signal 228 that is provided for playback. In some other implementations, the audio mixing system 200 includes an audio signal post-processing 226 to process the mixed audio signal 224 to generate the output signal 228.

The fixed beamformer may provide audio beams 211 to the audio signal processing 209 frame-by-frame (which is also referred to as a frame level). A frame includes a plurality of samples, with each sample being a point in time measurement of the audio beams. As described below, processing audio beams 211 at the frame level instead of the sample level by the audio signal processing 209 may reduce the number of computing operations and time required to process the same length of audio beams 211.

In some implementations, the audio mixing system 200 is configured to process the audio signals 204 in the frequency domain. As such, operations of the fixed beamformer 208 and the audio signal processing 209 may be in the frequency domain. However, the mixer 222 may be configured to mix the audio beams 211 in the time domain.

If the audio mixing system 200 is configured to process the audio signals in the frequency domain, the fixed beamformer 208 is to operate in the frequency domain (such as the fixed beamformer 208 performing Fast Fourier Transformer (FFT) convolution), with the audio signal processing 209 processing the audio beams 211 in the frequency domain. For example, the fixed beamformer 208 may include FFT-based FIR filters to generate the beams 211 at a frame level (with generating gains 220 by the audio signal processing 209 occurring at the frame level).

Alternative to processing the audio signals 204 in the frequency domain by the fixed beamformer 208 and the audio signal processing 209, in some implementations, the audio mixing system 200 may process the audio signals 204 completely in the time domain. In such implementations, the fixed beamformer 208 may include time-based FIR filters. In addition, the gains 220 and the mixed audio signal 224 may be generated at the sample level.

As noted above, the audio signal processing 209 generates a gain 220 for each audio beam 211, with the gains 220 used by the mixer 222 for mixing the audio beams 211. To generate the gains 220, the audio signal processing 209 reduces the noise components of the beams 211 to generate the reduced noise audio beams 212, calculates signal characteristics 216 (such as an SNR or signal level) based on the reduced noise audio beams 212, and generates the gains 220 based on the signal characteristics 216. In some implementations, the audio signal processing 209 may also calculate a direction of arrival (DOA) of audio received at the microphone array 202 and generate a control signal 232 to control another device (such as a camera or a loudspeaker at the end playing the output signal 228) based on the DOA. The audio signal processing 209 includes a noise reduction unit (NRU) 210, a signal logic 214, and a gain generator 218. In some implementations, the audio signal processing 209 also includes a DOA logic 230.

The NRU 210 processes each of the audio beams 211 to reduce noise in the beams 211 to generate the reduced noise audio beams 212. As noted above, each beam 211 is comprised of a speech component and a noise component based on the speech components and the noise components of the audio signals 204 used to generate the audio beam 211. As such, the NRU 210 reduces the noise component of an audio beam a₁ to generate a reduced noise audio beam r₁, reduces the noise component of an audio beam a₂ to generate a reduced noise audio beam r₂, up to reducing the noise component of an audio beam aₘ to generate a reduced noise audio beam rₘ.

In some implementations, the NRU 210 includes m number of neural network (NN) noise reduction units (NNNRU), with each NNNRU dedicated to processing a specific audio beam 211 to generate a corresponding reduced noise audio beam 212. For example, a first NNNRU processes audio beam a₁ to generate r₁, a second NNNRU processes audio beam a₂ to generate r₂, up to NNNRU m processing audio beam aₘ to generate rₘ.

Each NNNRU includes a recurrent neural network (RNN) to receive an audio beam 211 and output a reduced noise audio beam 212. In some implementations, the RNN is a three layer fully recurrent neural network. If the NNNRU is to receive the audio beam 211 in the frequency domain, the input layer of the RNN includes a plurality of input nodes, with each node configured to receive a frequency band of the audio beam 211. In some implementations, the RNN includes 256 input nodes to receive 256 different frequency bands of the audio beam 211, with each frequency band being 30 Hz in size.

Before an NNNRU is used in practice, the NNNRU is trained to determine the node weights. Training may include supervised learning, with the training data to train the NNNRU including previously obtained audio beams as input beams to the NNNRU and desired output beams corresponding to the input beams used to generate a training loss based on a defined loss function for the NNNRU. Training may include recursively inputting the audio beams, generating the reduced noise audio beams, generating a training loss between the reduced noise audio beams and the desired output beams, and adjusting the node weights of the RNN a number of epochs until the NNNRU is trained. In some implementations of training the NNNRU, the Adam optimization algorithm is used in completing the training of the NNNRU.

In some other implementations alternative to the NRU 210 including a plurality of NNNRUs, the NRU 210 may apply a non-artificial intelligence (AI) algorithm to the audio beams 211 to generate the reduced noise audio beams 212. Example non-AI algorithms include spectral subtraction, Wiener Filtering, and the Ephraim-Malah noise reduction algorithm. However, in comparing an NRU including NNNRUs as compared to using non-AI algorithms, an NNNRU removes more non-speech sounds (i.e., more of the noise component) from a signal, including sounds with non-stationary statistical properties, such as music, incoherent murmuring, and babble, and percussive sounds, such as keyboard taps or a pencil tapping on a table. In addition, an NNNRU better preserves target speech sounds in an audio signal with less distortion. In particular, an NNNRU may be aggressive in removing a noise component from an audio signal as compared to non-AI means for noise reduction for beamforming and audio mixing. In addition, since the NNNRU output is used only for estimating a signal characteristic (such as a signal level or a noise level to estimate an SNR) and is not heard by a person, a smaller, less difficult to implement NNNRU may be implemented for each beam only to be able to estimate the signal characteristic 216. For example, each NNNRU may be limited to less than 100000 parameters, which is still effective in removing non-speech noise without concern over signal quality of the resulting reduced noise audio beams. Such smaller NNNRUs may require fewer processing resources and time to be executed than non-AI algorithms to perform noise reduction.

In some implementations, the NRU 210 may shape the audio beams 211. For example, the NRU 210 may include a bandpass filter that is applied to each audio beam 211 to attenuate the low frequencies and the high frequencies of each audio beam 211 before generating the noise reduced audio beam 212. In some implementations, the bandpass filter is preconfigured based on a defined weighting curve. For example, an A-weighting curve may be defined and used. In some other implementations, a processing system may configure the bandpass filter based on an unweighted signal level of a current frame of the audio beam. In some implementations, the NRU 210 may determine when to apply the filter based on the signal level of the audio beam 211 being above or below a defined threshold. For example, if an unweighted signal level of the current frame of the audio beam 211 is below a defined threshold, the NRU 210 does not apply the filter. Conversely, if the unweighted signal level of the current frame of the audio beam 211 is above the threshold, the NRU 210 applies the filter. In this manner, filtering the audio beam 211 for noise reduction by the audio signal processing 209 may be selective.

With the reduced noise audio beams 212 generated (such as a current frame of the reduced noise audio beams 212 being generated), the signal logic 214 receives the reduced noise audio beams 212 generated by the NRU 210 and generates the signal characteristics 216 based on the reduced noise audio beams 212. While not depicted in FIG. 2, the signal logic 214 may also receive the audio beams 211 to generate the signal characteristics 216. A signal characteristic is generated for each reduced noise audio beam 212 and thus for each audio beam 211. For example, the signal logic 214 may generate signal characteristic s₁ from reduced noise audio beam r₁ (and optionally from audio beam a₁), may generate signal characteristic s₂ from reduced noise audio beam r₂ (and optionally from audio beam a₂), up to generating signal characteristic sₘ from reduced noise audio beam rₘ (and optionally from audio beam aₘ).

In some implementations, a signal characteristic 216 includes a signal level of a reduced noise audio beam 212. The signal logic 214 may calculate a signal level of an audio signal as an instantaneous power level of the audio signal (such as the reduced noise audio beam). In some other implementations, the signal characteristic 216 includes an SNR of an audio beam 211. The SNR is an energy ratio of desired signal components (such as a speech component) to noise components of the audio beam 211. The SNR may be measured as a ratio between the signal level of the reduced noise audio beam and the noise level of the noise component of the audio beam used to generate the reduced noise audio beam.

The signal logic 214 may estimate the noise level of an audio beam 211 to calculate the SNR of the audio beam 211. In some implementations of estimating a noise level of an audio beam 211, the signal logic 214 calculates a first signal level of the audio beam 211, and the signal logic 214 calculates a second signal level of the reduced noise audio beam 212 corresponding to the audio beam 211. The signal logic 214 then calculates an estimated noise level as a difference between the first signal level and the second signal level (thus calculating a signal level of what is removed by the NRU 210 from the audio beam 211 as an estimate of the noise component). If the NRU 210 applies a filter to an audio beam 211 before generating the reduced noise audio beam 212, the first signal level of the audio beam 211 may be calculated as a signal level of the filtered audio beam. To note, if the audio signal processing 209 processes the audio beams 211 at the frame level, the filtering occurs at the frame level, and thus the first signal level (as well as the second signal level) is calculated at the frame level. Examples of the first signal level that may be calculated by the signal logic 214 include an L1 norm, an L2 norm, and a Root mean square (RMS) value.

In some other implementations of estimating a noise level of an audio beam 211, the noise level is estimated based on a filter mask associated with the NNNRU that processes the audio beam 211 to generate the corresponding reduced noise audio beam 212. The filter mask is a real vector or a complex vector of values for different frequency components that an audio signal may include, with each value representing a noise level of a unique frequency component (such as a defined frequency band). It is assumed that if the filter mask would be applied to an audio signal, a low noise (or noiseless) audio signal would be generated. The magnitude of each frequency component is in a range from zero to one, with a value of one indicating that the frequency component of a signal includes no noise and a value of zero indicating that the frequency component of the signal includes nothing but noise. The NNNRU after training may be configured to generate and provide the filter mask, or the filter mask may be determined based on observations and testing of the trained NNNRU using different audio signals input to the trained NNNRU and observing the outputs of the trained NNNRU.

A final mask to be used for estimating a noise level of an audio signal is a noise spectrum mask, with the values of the noise spectrum mask indicating the amount of noise in a signal for each frequency component across the frequency spectrum of the signal. The noise spectrum mask may be generated from the filter mask associated with the NNNRU. For example, each real value of the vector (which may be a vector of real values or a vector of complex values) of the filter mask may be subtracted from one to generate a final vector of the noise spectrum mask. As such, if the vector of the filter mask and the final vector of the noise spectrum mask would be added together, each real value of the resulting vector would equal one. To calculate a noise level of an audio beam 211, the signal logic 214 may include the noise spectrum mask or retrieve the noise spectrum mask stored in a memory and apply the noise spectrum mask to the audio beam 211 (thus multiplying a real value corresponding to a frequency component of the audio beam 211 to the corresponding frequency component of the audio beam 211) to estimate a noise component of the audio beam 211 as a vector of values. The signal logic 214 may then measure a signal level of the estimated noise component as the noise level of the audio beam 211.

With the noise level calculated, the signal logic 214 calculates the SNR of the audio beam 211 as a ratio of the second signal level (of the reduced noise audio beam 212) to the noise level, such as dividing the second signal level by the noise level to generate the SNR.

The gain generator 218 receives the signal characteristics 216 and generates gains 220 for the audio beams 211. For example, the gain generator 218 generates a gain g₁ from a signal characteristic s₁, generates a gain g₂ from a signal characteristic s₂, up to generating a gain gₘ from a signal characteristic sₘ. The gain generator 218 may also perform functions of the BSLU for beam selection, and as such, the gain generator may also be referred to herein as a BSLU. The gains 220 (which may also be referred to as gain coefficients) are provided to the mixer 222 to be combined with the audio beams 211. For example, the mixer 222 multiplies audio beam a₁ with gain g₁, multiplies audio beam a₂ with gain g₂, up to multiplying audio beam aₘ with gain gₘ. The mixer 222 then combines the gain corrected audio beams to generate the mixed audio signal 224. For example, the mixer 222 may sum the gain corrected audio beams to generate the mixed audio signal 224.

Referring back to the gain generator 218 of the audio signal processing 209, in some implementations, a gain 220 for an audio beam 211 may be calculated as a single value if the audio signal processing 209 processes audio beams 211 at a sample level. In some other implementations, the gain 220 for the audio beam 211 may be calculated as a vector of values if the audio signal processing 209 processes audio beams 211 at a frame level, with the size of the vector equaling the length of the frame (i.e., the number of samples) of the audio beam 211. In this manner, the gain may be applied by the mixer 222 to the audio beam 211 on a sample-by-sample basis such that a smoothed gain change can occur from frame to frame of the mixed audio signal, thus avoiding sudden gain changes that degrades sound quality of the mixed audio signal 224.

Generating a gain 220 for a beam 211 may be based on whether the beam 211 is considered “active,” which indicates that the beam is to be emphasized in the mixed audio signal 224. Identifying that a beam is active may also be referred to as selecting the beam. Selecting a beam 211 may be based on, e.g., the signal characteristic 216 for the beam 211 being greater than a threshold, the signal characteristic 216 for the beam 211 being greater than all other signal characteristics 216, the signal characteristic 216 for the beam 211 being one of a fixed subset size of signal characteristics 216 that each have a greater signal characteristic than all of the remaining signal characteristics 216, an increase in the signal characteristic 216 between frames being greater than a threshold, or a combination of the signal characteristic 216 for the beam 211 being greater than a threshold and greater than the other signal characteristics 216. To note, selecting a beam 211 and selecting a noise reduced beam 212 are used interchangeably herein. A threshold to which to compare a signal characteristic is referred to herein as an activation threshold. If the audio signal processing 209 processes the audio beams 211 at the frame level, beam selection occurs at the frame level. If the audio signal processing 209 processes the audio beams 211 at the sample level, beam selection occurs at the sample level.

In some implementations of generating the gains 220, the gain generator 218 may compare the signal characteristics 216, identify the greatest signal characteristic based on the comparison, and select the beam 211 corresponding to the greatest signal characteristic 216. For example, the gain generator 218 selects the audio beam 211 with the highest signal level of the corresponding reduced noise audio beam 212 or the highest SNR of the audio beam 211. In some other implementations, the gain generator 218 may compare each signal characteristic 216 to an activation threshold. The activation threshold may be predefined in the audio mixing system 200 or may be provided by a user as a parameter to the audio mixing system 200. The gain generator 218 may thus select the audio beams 211 whose signal characteristics are greater than the activation threshold.

In some implementations, the gain generator 218 calculates the activation threshold for a single frame based on the signal characteristics 216 across the beams 211 and a sensitivity parameter (which may be predefined in the audio mixing system 200 or may be provided by a user). For example, the gain generator 218 may calculate the activation threshold as depicted in equation (1) below:

Threshold=mean(S)+sens*stdev(S) (1)

S is the vector of signal characteristics s₁ to sₘ, sens is the sensitivity parameter, mean is the averaging operation, and stdev is the standard deviation operation. As depicted in equation (1), the activation threshold is a summation of an averaging component and a weighted standard deviation component of vector S. The sensitivity parameter is a scalar value that weights the standard deviation component and thus adjusts equation (1) as to how many beams may be considered active. For example, if the sensitivity parameter increases, the standard deviation component increases and the activation threshold increases. If the activation threshold increases, less beams may have a signal characteristic greater than the activation threshold. Conversely, if the activation threshold decreases, more beams may have a signal characteristic greater than the activation threshold. With the activation threshold calculated as depicted in equation (1), the activation threshold is independent of the absolute signal level of the beams. In this manner, comparison of the beams to such an activation threshold is an indirect comparison of the beams' signal characteristics to one another, with the selectivity of the gain generator 218 able to select a beam being dependent on the sensitivity parameter.

If the comparison of the signal characteristics 216 is on a frame basis, the gain generator 218 generates the gain 220 for a selected beam 211 to fade from a previous value towards a value of unity over the frame and generates the gain 220 for an unselected beam 211 from a previous value towards a value of zero over the frame. In some implementations, fading a gain towards unity refers to fading or increasing the gain towards one over the frame, and fading a gain towards zero refers to fading or decreasing the gain towards 1e⁻³ (which is approximately −60 decibels (dB)). As such, each gain 220 may be in a range from 1e⁻³ to 1.

Fading may be based on a defined constant configured in the audio mixing system 200 and on which the rate of change of the gains depends. For example, a larger constant may quicken the fading of the gain to unity or towards zero, and a smaller constant may slow the fading of the gain to unity or towards zero. In some implementations, a different constant is used for fading to unity than for fading towards zero. In this manner, the rate of change of a gain to unity may be greater or less than the rate of change of a gain towards zero. For example, it may be desired to more quickly emphasize a beam in the mixed audio signal 224 identified as having the highest SNR to attempt to capture the beginning of words if speech just begins in the beam, but it may also be desired to prevent deemphasizing other beams to prevent fluctuations in sounds in the mixed audio signal 224. As such, the constant defined for fading the gain to unity (thus emphasizing a beam) may be greater than the constant defined for fading the gain towards zero (thus deemphasizing a beam).

Such generated gains 220 are provided to the mixer 222, and the mixer 222 generates the mixed audio signal 224 from the beams 211 to transition between beams 211 in a time smoothed manner over the frame based on the gains 220.

In some other implementations of generating the gains 220, the gains 220 may be based on which beams recently included a speech component but may not currently include a speech component (i.e., which beams were recently selected but may not be currently selected). As such, a persistence may be included in the generation of the gain to slow the change in a gain for a beam that recently included a speech component but does not currently include a speech component. For example, if a beam was selected in a previous frame but is not selected in a current frame, the gain generator 218 may temporarily prevent fading the gain for the beam in the current frame based on the beam recently having been selected.

In some implementations, the gain generator 218 determines, for each reduced noise audio beam 212, whether a current frame of the reduced noise audio beam 212 includes a speech component. For example, the gain generator 218 may compare the signal characteristics 216 to the activation threshold to select audio beams 211. As such, if the signal characteristic 216 is a signal level, the gain generator 218 compares the signal level to a signal level threshold. If the signal characteristic 216 is an SNR, the gain generator 218 compares the SNR to an SNR threshold. The activation threshold may be the same across the beams, or the activation threshold may differ between beams for beam selection. For example, based on a known layout of the environment, a beam may focus on a location in the environment from which the microphone array has difficulties capturing speech components. As such, the activation threshold for that beam may be defined to be lower than for other beams. As noted above, an activation threshold may be predefined in the audio mixing system 200 or may be a parameter to be provided by a user of the audio mixing system 200.

The gain generator 218 generates a time measurement based on when the reduced noise audio beam includes a speech component (e.g., based on when is selected). In some implementations, the audio mixing system 200 includes a counter for each reduced noise audio beam 212, with the counters stored in a memory. For each reduced noise audio beam 212, the corresponding counter counts a number of frames of the reduced noise audio beam 212 that includes a speech component. For example, the counter counts a number of frames for which the reduced noise audio beam is selected by the gain generator 218. In counting the number of frames, the counter increments by one or more in response to determining that the reduced noise audio beam 212 includes the speech component in the current frame of the reduced noise audio beam (such as the reduced noise audio beam 212 being selected by the gain generator 218 for the current frame as a result of the signal characteristic 216 being greater than the activation threshold). In addition, the counter decrements by one or more in response to determining that the reduced noise audio beam 212 does not include the speech component in the current frame of the reduced noise audio beam (such as the reduced noise audio beam 212 not being selected by the gain generator 218 for the current frame as a result of the signal characteristic 216 being less than the activation threshold).

When a counter stores a value greater than zero during a current frame, the gain generator 218 prevents fading the gain 220 for the corresponding beam 211. Each counter may be configured to count up to a maximum value that represents the time limit of the persistence in preventing fading a gain for the beam 211 towards zero. For example, a counter may indicate a number of frames to prevent fading a gain for the corresponding beam 211 towards zero. As such, if the counter indicates a value of one, fading the gain for the corresponding beam 211 towards zero is prevented for one frame. Once the counter decrements to a value of zero, the gain generator 218 may fade the gain for the corresponding beam 211 towards zero if the beam is not selected for the frame. The maximum number to which a counter may count may be based on the counter size. For example, if a counter is an 8-bit counter, the counter may count up to 255, thus indicating waiting at most 255 frames before fading the gain for the corresponding beam towards zero. If a frame size is 16 ms, the gain generator 218 may prevent fading the gain for the beam for up to approximately four seconds (16 ms times a maximum of 255). If a frame size is 32 ms, the gain generator 218 may prevent fading the gain for the beam for up to approximately 8 seconds (32 ms times a maximum of 255). If a counter is a 4-bit counter, the counter may count up to 15, and the gain generator 218 may prevent fading the gain for the beam for up to 240 ms for a 16 ms frame size or up to 480 ms for a 32 ms frame size. Any suitable size counter may be used to count frames, and any suitable frame size may be used to process the audio signals 204 and the beams 211.

In some implementations, the increment size for a counter when a beam is selected may be greater than a decrement size for the counter when the beam is not selected. For example, the gain generator 218 may decrement the counter by one for a current frame in response to the gain generator 218 not selecting the beam, but the gain generator 218 may increment the counter by two (or more) for a current frame in response to the gain generator 218 selecting the beam. To note, the counter does not decrement to less than zero, and the counter does not increment to greater than the maximum value.

With each of the counters updated for a frame, the gain generator 218 generates the gains 220 for the selected beams 211 for the current frame as described above. As for each beam 211 that is not selected for the current frame, the gain generator 218 identifies whether the corresponding counter is at zero. If the counter is at zero, the gain generator 218 reduces (fades) the gain 220 for the beam 211 from a current value towards zero for the current frame. If the counter is not at zero, the gain generator 218 generates the gain to be constant at the current value throughout the frame, thus preventing fading the gain 220 during the current frame.

Referring back to the signal logic 214, in some implementations, the signal characteristic 216 may be generated based on a normalized signal level. As such, the signal logic 214 may normalize the reduced noise audio beams 212 (and optionally the audio beams 211) to generate the signal characteristics 216 from the normalized beams. In some other implementations, the signal characteristic 216 may be generated based on a non-normalized signal level. As such, the reduced noise audio beams 212 may not be normalized before generating the signal characteristics 216 for generating the gains 220.

In some implementations, whether to normalize the noise reduced audio beams 212 (and optionally the audio beams 211) by the signal logic 214 to generate the signal characteristics 216 is based on whether any of the reduced noise audio beams 212 are determined to include a speech component based on the non-normalized signal levels of the reduced noise audio beams 212. If determined that any of the reduced noise audio beams 212 includes a speech component based on the non-normalized signal levels, the reduced noise audio beams 212 (and optionally the audio beams 211) may be normalized to generate the signal characteristics 216. As such, beam selection at the gain generator 218 is based on normalized signal levels (which applies for the signal characteristic being a signal level or an SNR). Otherwise, the reduced noise audio beams 212 are not normalized before generating the signal characteristics 216. As such, beam selection at the gain generator 218 is based on non-normalized signal levels (which applies for the signal characteristic being a signal level or an SNR).

In some implementations, the signal logic 214 estimates a non-normalized signal level of each reduced noise audio beam 212 for a current frame, and the signal logic 214 compares the non-normalized signal level to a non-normalized threshold predefined at the signal logic 214 to generate a voice activity decision (which is a single-bit, binary decision). If the non-normalized signal level is greater than the non-normalized threshold, the voice activity decision is positive (equal to one), and if the non-normalized signal level is less than the non-normalized threshold, the voice activity decision is negative (equal to zero). The signal logic 214 may combine (such as average) the voice activity decisions across the reduced noise audio beams 212 for the current frame and compare the combined value (such as the average value) to an overall threshold. If the combined value is greater than the overall threshold, the signal logic 214 determines that at least one of the reduced noise audio beams 212 includes a speech component. As such, the signal logic 214 may normalize all reduced noise audio beams 212 (and optionally all audio beams 211) for the current frame to generate the signal characteristics 216, thus causing the gain generator 218 to select beams using normalized signal levels. In some other implementations to normalizing the beams for gain generation, the gain generator 218 may use non-normalized beams for gain generation.

As described above, the audio signal processing 209 generates the gains 220 for the audio beams 211 so that the mixer 222 may generate the mixed audio signal 224. As noted above, mixing the audio beams 211 may include multiplying each audio beam 211 by the corresponding gain 220 for the current frame. The mixer 222 may then combine the processed audio beams to generate the mixed audio signal 224. For example, the mixer 222 may add the processed audio beams together to generate the mixed audio signal.

In some implementations, the mixed audio signal 224 is ready for playback. In some other implementations, the audio mixing system 200 includes an audio signal post-processing 226 to process the mixed audio signal 224 to generate the output signal 228. For example, the audio signal post-processing 226 may include a noise reduction system to reduce or remove a noise component of the mixed audio signal 224. In some implementations, the noise reduction system includes a single NNNRU to process the mixed audio signal 224. Since the output audio signal 228 from the NNNRU is to be played back, the NNNRU of the audio signal post-processing 226 may be of a higher quality than the NNNRUs included in the NRU 210. For example, the number of parameters (and optionally the number of layers) may be more (which may be significantly more, such as by a factor of five or more) than for each NNNRU of the NRU 210. A higher quality NNNRU may better preserve the signal quality of the output signal 228 while reducing or removing the noise component of the mixed audio signal 224. Training the NNNRU of the audio signal post-processing 226 may be performed in a similar fashion as training an NNNRU of the NRU 210. In some other implementations, the noise reduction system of the audio signal post-processing 226 may include a system to implement non-AI noise reduction algorithms, such as described above with reference to the NRU 210.

In addition or alternative to the audio signal post-processing 226 including a noise reduction system, the audio signal post-processing 226 may include one or more of an automatic GCU, a signal equalization system, an acoustic echo canceling system, a dereverberation system, an audio signal encoder, or a sample rate converter. With the output signal 228 generated by the audio mixing system 200, the output signal 228 is transmitted to a speaker for playback (such as to a far-end device for a teleconference or for live media streaming). Additionally or alternatively, the output signal 228 may be placed into storage (such as for a recording for future playback).

As described above, the audio mixing system 200 generates the output signal 228 for playback. Also as noted above, in some implementations, the environment for recording and playing back audio is for scenarios in which video may also be recorded (such as for a video teleconference or a video stream or broadcast). For example, as depicted in FIG. 1, an environment may include one or more cameras (depicted as camera 126). Additionally or alternatively, for a teleconference, a theatre playing a concert, or other environments in which spatial audio playback may be desired, a playback environment may include a speaker configuration that may be able to mimic the location of the audio received in the recording environment.

In some implementations, the audio signal processing 209 includes a DOA logic 230 to generate a control signal 232 to control one or more of an audio unit or a video unit. As noted above, each beam is associated with a specific direction from the microphone array 202 in the environment or a specific location in the environment, with the direction or location known for each beam. As such, the DOA logic 230 may generate a control signal 232 based on the beams selected for a current frame by the gain generator 218.

For example, the DOA logic 230 may calculate a DOA of audio to the microphone array 202 based on the reduced noise audio beams 212 that include a speech component. To calculate the DOA, the gain generator 218 may provide an indication of the beams that are selected for a current frame in an active beam indicator 234 to the DOA logic 230. The DOA logic 230 may have a mapping stored of environment locations or directions to beams or may retrieve such a mapping stored in a memory. If one beam is selected and the mapping maps known directions to beams, the DOA logic 230 uses the active beam indicator 234 to perform a lookup in the mapping to obtain the direction for the beam as the DOA. If more than one beam is selected, the DOA logic 230 uses the active beam indicator 234 to perform a lookup in the mapping to obtain a plurality of directions. The DOA logic 230 may then calculate an average direction from the plurality of directions as the DOA. With the DOA calculated, the DOA logic 230 may generate the control signal 232 to control one or more of an audio unit or a video unit based on the DOA. For example, the DOA logic 230 may convert the DOA to a camera orientation for camera 126, and the DOA logic 230 may format the camera orientation into a defined format of an application programming interface (API) for the camera 126, which may be provided to a control system for the camera 126 via the API. The control system may thus move the camera (such as rotate the camera and zoom the camera) based on the control signal 232 to, e.g., focus on a current speaker. A similar process may additionally or alternatively be performed for indicating a direction of received audio to synthesize a location or direction of playback of the output signal 228 by an audio system.

As noted above, the audio mixing system 200, and in particular the audio signal processing 209, may be implemented in software that is stored in a memory and executed by a processing system.

FIG. 3 shows a block diagram of an example system 300 with at least some components of an audio mixing system implemented in software, according to some implementations. In some implementations, the system 300 is an example implementation of at least a portion of the audio mixing system 200 of FIG. 2. For example, the system 300 may implement the components of the audio signal processing 209 in FIG. 2. As such, the NRU 336 is an example implementation of the NRU 210 in FIG. 2, the signal logic 338 is an example implementation of the signal logic 214 in FIG. 2, and the gain generator 340 is an example implementation of the gain generator 218 in FIG. 2. If the audio signal processing 209 includes DOA logic 230, the DOA logic 346 is an example implementation of the DOA logic 230 in FIG. 2.

If the components of the audio mixing system 200 external to the audio signal processing 209 are not implemented in the system 300 (such as the beamformer, the mixer, and pre and post processing), the system 300 may be configured to provide at the interface 310 an output 312 of the gains generated by the system 300 (such as gains 220 in FIG. 2) and, optionally, a control signal generated by the system 300 (such as the control signal 232 in FIG. 2). The input 314 to the system 300 may include frames of audio beams to be processed (such as audio beams 211 in FIG. 2) and, optionally, a sensitivity parameter or other parameters from a user. In such an implementation, the interface 310 may be an API for communicating with the other components of the audio mixing system 200 (such as the fixed beamformer 208 and the mixer 222 in FIG. 2) or with a user interface.

In some implementations, one or more additional components of the audio mixing system 200 are implemented in the system 300. For example, the audio signal pre-processing 332 is an example implementation of the audio signal pre-processing 206 in FIG. 2, the fixed beamformer 334 is an example implementation of the fixed beamformer 208 in FIG. 2, the mixer 342 is an example implementation of the mixer 222 in FIG. 2, and the audio signal post-processing 344 is an example implementation of the audio signal post-processing 226 in FIG. 2. In such an implementation, the interface 310 may be an API or a physical interface, and the interface 310 may communicate with the microphone array 202 to receive the audio signals 204 as input 314. The interface may also communicate with another device (such as a far-end teleconference device, an audio or video playback device, or a recording device) and provide an output 312 that may include one or more of the output signal 228, the mixed audio signal 224, or the control signal 232.

The memory 330 may include an audio data store 331 configured to store frames of the audio signals as well as any intermediate signals, beams, signal characteristics, gains, mixed signals, or other data that may be produced by the system 300 in generating the output audio signal for playback. The memory 330 also may include a non-transitory computer-readable medium (including one or more nonvolatile memory elements, such as EPROM, EEPROM, Flash memory, or a hard drive, among other examples) that may store at least the following software (SW) modules:
an NRU 336 to generate reduced noise audio beams from beams generated by a fixed beamformer;
a signal logic 338 to calculate signal characteristics for the reduced noise audio beams; and
a gain generator 340 to generate gains for the beams generated by the fixed beamformer based on the signal characteristics and for mixing the beams to generate an output audio signal for playback.

The memory 330 also may store the following SW modules:
an audio signal pre-processing 332 to process the audio signals from a microphone array before generating beams from the audio signals by a fixed beamformer;
a fixed beamformer 334 to generate the beams from the audio signals;
a mixer 342 to mix the beams from the fixed beamformer based on the generated gains to generate a mixed audio signal;
an audio signal post-processing 344 to process the mixed audio signal from a mixer to generate the output audio signal for playback; and
a DOA logic 346 to calculate a DOA and generate a control signal to control one or more of an audio device or a video device.
   Each software module includes instructions that, when executed by the processing system 320, cause the system 300 to perform the corresponding functions described above with reference to FIG. 2.

The processing system 320 may include any suitable one or more processors capable of executing scripts or instructions of one or more software programs stored in the system 300 (such as in the memory 330). For example, the processing system 320 may execute one or more of the audio signal pre-processing 332, the fixed beamformer 334, the NRU 336, the signal logic 338, the gain generator 340, the mixer 342, the audio signal post-processing 344, or the DOA logic 346.

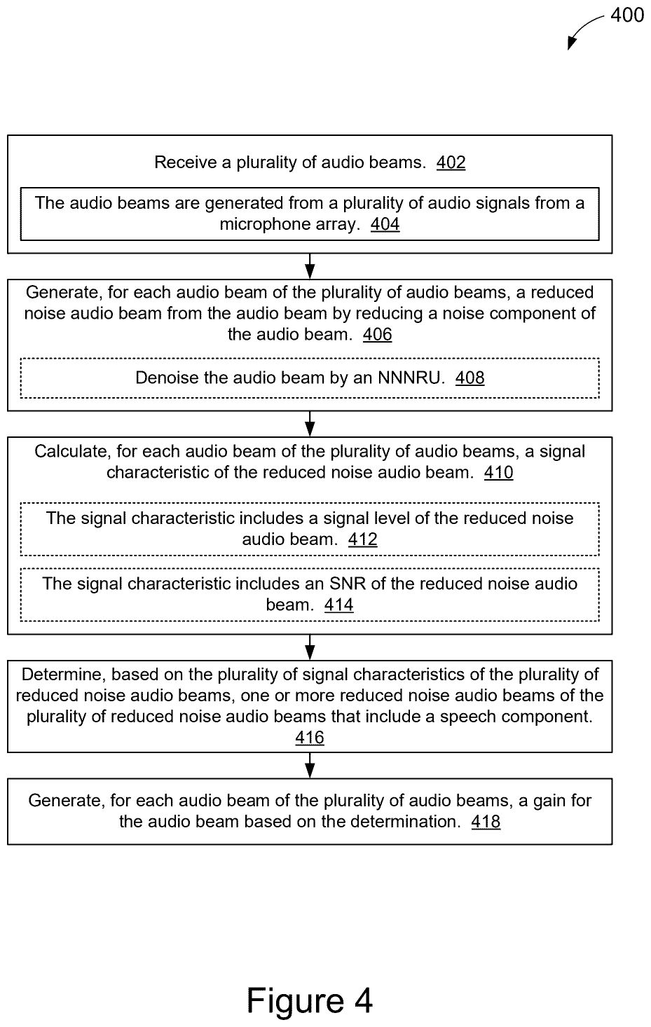

FIG. 4 shows an illustrative flowchart depicting an example operation 400 for generating gains for audio mixing, according to some implementations. In some implementations, the example operation 400 may be performed by an audio signal processing system, such as the audio signal processing 209 in FIG. 2 that may be implemented in the system 300 in FIG. 3. As such, operation 400 is described below with reference to the system 300 in FIG. 3 performing the functions of the operation 400.

The system 300 receives a plurality of audio beams (402). The audio beams are generated from a plurality of audio signals from a microphone array (404). For example, the audio signal processing 209 receives the audio beams 211 from the fixed beamformer 208, with the audio beams 211 generated from the audio signals 204 from the microphone array 202.

The system 300 generates, for each audio beam of the plurality of audio beams, a reduced noise audio beam from the audio beam by reducing a noise component of the audio beam (406). In some implementations, the system 300 denoises the audio beam by an NNNRU (408). For example, the NRU 210 generates a reduced noise audio beam 212 for each audio beam 211, such as by applying an NNNRU dedicated to denoising a specific audio beam to generate the corresponding reduced noise audio beam. To reduce the noise component of the audio beam to generate the reduced noise audio beam 212 using an NNNRU, the system 300 inputs the audio beam to the NNNRU dedicated to processing the audio beam. As noted above, the NNNRU includes an RNN configured to receive samples of the audio beam based on a frequency spectrum of the audio beam. For processing the audio beam at a frame level, receiving samples may refer to receiving a frame of samples of the audio beam. With the received samples at the NNNRU, the system 300 denoises the audio beam to generate the reduced noise audio beam by the NNNRU.

The system 300 calculates, for each audio beam of the plurality of audio beams, a signal characteristic of the reduced noise audio beam (410). In some implementations, the signal characteristic includes a signal level of the reduced noise audio beam (412). In some other implementations, the signal characteristic includes an SNR of the reduced noise audio beam (414). For example, the signal logic 214 may generate, for each reduced noise audio beam 212, a signal level or an SNR of the reduced noise audio beam 212 as a signal characteristic of the reduced noise audio beam 212.

The system 300 determines, based on the plurality of signal characteristics of the plurality of reduced noise audio beams, one or more reduced noise audio beams of the plurality of reduced noise audio beams that include a speech component (416). For example, the gain generator 218 may compare each signal characteristic 216 to an activation threshold (such as a threshold calculated as depicted in equation (1) above) and select the one or more reduced noise audio beams 212 that that have a signal characteristic 216 greater than the activation threshold.

The system 300 generates, for each audio beam of the plurality of audio beams, a gain for the audio beam based on the determination (418). For example, for each of the one or more reduced noise audio beams 212 selected by the gain generator 218 for a current frame based on the signal characteristic 216, the gain generator 218 may generate a gain for the corresponding audio beam 211 that fades the gain from a current value of the gain towards unity (such as one). For each of the one or more reduced noise audio beams 212 not selected by the gain generator 218 for a current frame based on the signal characteristic 216, the gain generator 218 may generate a gain for the corresponding audio beam 211 that fades the gain from a current value of the gain towards zero. A gain for a frame may be a vector of values that includes a number of gain values equal to a number of samples in the frame.

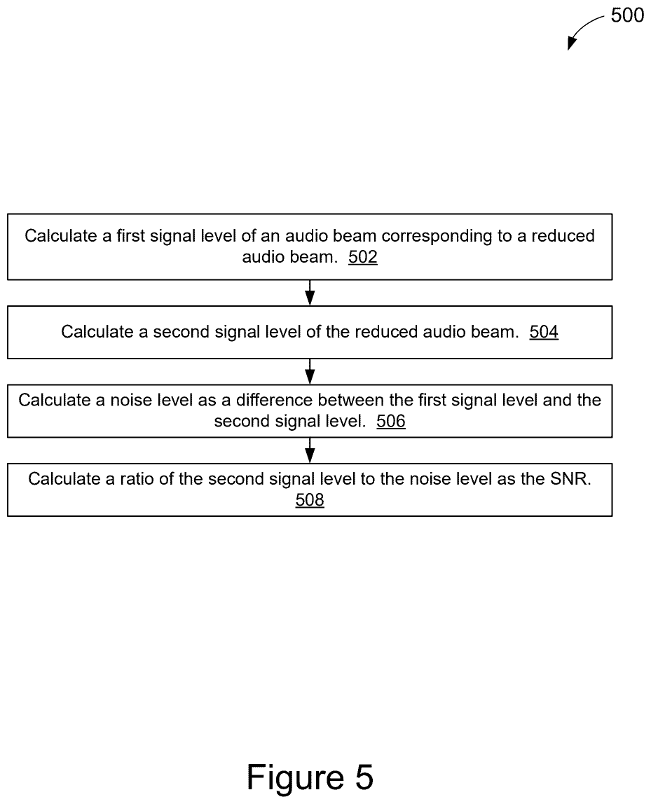

Referring back to block 410 of the example operation 400 in FIG. 4, the signal level calculated for a reduced noise audio beam may indicate an instantaneous signal power of the reduced noise audio beam. The SNR calculated for a reduced noise audio beam may indicate a ratio between the signal level of the reduced noise audio beam and a noise level of the noise component of the audio beam corresponding to the reduced noise audio beam. If the signal characteristics are SNRs, an example operation of calculating an SNR is depicted in FIG. 5.

FIG. 5 shows an illustrative flowchart depicting an example operation 500 for calculating an SNR for an audio beam, according to some implementations. Operation 500 is an example implementation of block 410 of operation 400 in FIG. 4 for a single audio beam, and operation 500 may be performed a plurality of times for the different audio beams to calculate the SNR for each audio beam. In some implementations, the example operation 400 may be performed by an audio signal processing system, such as the signal logic 214 of the audio signal processing 209 in FIG. 2 that may be implemented in the system 300 in FIG. 3. As such, operation 500 is described below with reference to the system 300 in FIG. 3 performing the functions of the operation 500.

The system 300 calculates a first signal level of an audio beam corresponding to a reduced audio beam (502). The system 300 also calculates a second signal level of the reduced audio beam (504). The system 300 calculates a noise level as a difference between the first signal level and the second signal level (506). The system 300 calculates a ratio of the second signal level to the noise level as the SNR (508).

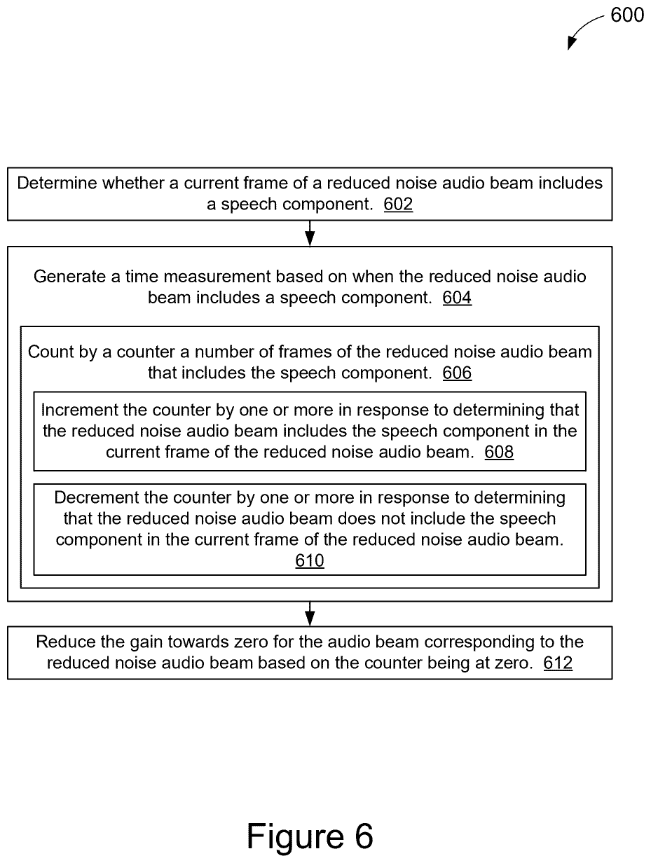

Referring back to block 418 of the example operation 400 in FIG. 4, as described above, generating a gain for an audio beam may be based on a history of the corresponding reduced noise audio beam being determined as including a speech component. An example operation of generating a gain for an audio beam based on a history of the corresponding reduced noise audio beam including a speech component is depicted in FIG. 6.

FIG. 6 shows an illustrative flowchart depicting an example operation 600 for generating a gain for an audio beam based on a time measurement indicating when a corresponding reduced noise audio beam includes a speech component, according to some implementations. Operation 600 is an example implementation of block 418 of operation 400 in FIG. 4 for a single audio beam, and operation 600 may be performed a plurality of times for the different audio beams to generate a gain for each audio beam. In some implementations, the example operation 600 may be performed by an audio signal processing system, such as the gain generator 218 of the audio signal processing 209 in FIG. 2 that may be implemented in the system 300 in FIG. 3. As such, operation 600 is described below with reference to the system 300 in FIG. 3 performing the functions of the operation 600.

The system 300 determines whether a current frame of a reduced noise audio beam includes a speech component (602). For example, the gain generator 218 compares the signal characteristic 216 (such as a signal level) of the reduced audio beam 212 to an activation threshold.

The system 300 generates a time measurement based on when the reduced noise audio beam includes a speech component (604). Generating the gain for the audio beam corresponding to the reduced noise audio beam is based on the time measurement. To generate the time measurement in block 604, the system 300 counts by a counter a number of frames of the reduced noise audio beam that includes the speech component (606). For example, the system 300 increments the counter by one or more in response to determining that the reduced noise audio beam includes the speech component in the current frame of the reduced noise audio beam (608). Conversely, the system 300 decrements the counter by one or more in response to determining that the reduced noise audio beam does not include the speech component in the current frame of the reduced noise audio beam (610). The counters for the audio beams may be stored in the memory 330, such as in the gain generator 340.

The system 300 reduces the gain towards zero for the audio beam corresponding to the reduced noise audio beam based on the counter being at zero (612). For example, while the counter is at a value greater than zero, the gain generator 218 prevents fading the gain 220 from a current value towards zero in the current frame. However, when the counter is at zero, the gain generator 218 fades the gain 220 from the current value towards zero in the current frame.

Referring back to blocks 410, 416, and 418 of the example operation 400 in FIG. 4, generating a gain may be based on selecting a beam based on normalized signal characteristics (and in particular normalized signal levels) and updating the counters based on such beam selection. As noted above, beam selection may be based on an activation threshold calculated as depicted in equation (1) above.

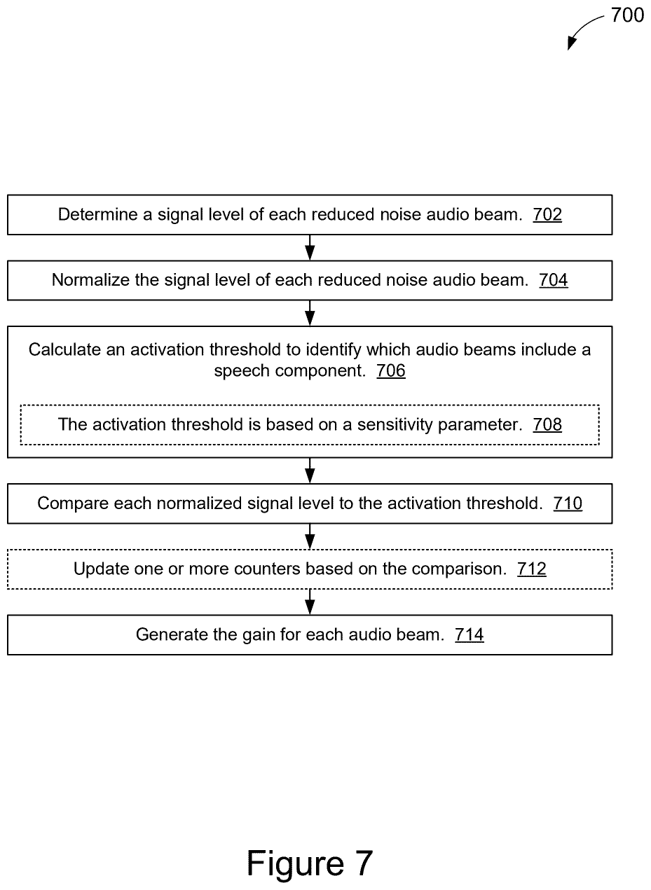

FIG. 7 shows an illustrative flowchart depicting an example operation 700 for generating a gain for each audio beam, according to some implementations. The gain generation is based on normalized signal levels for beam selection and may also be based on counters for the beams, such as described above with reference to FIG. 6. Operation 700 is an example implementation of blocks 410, 416, and 418 of operation 400 in FIG. 4. In some implementations, the example operation 700 may be performed by an audio signal processing system, such as the audio signal processing 209 in FIG. 2 that may be implemented in the system 300 in FIG. 3. As such, operation 700 is described below with reference to the system 300 in FIG. 3 performing the functions of the operation 700.

The system 300 determines a signal level of each reduced noise audio beam (702). The system 300 also normalizes the signal level of each reduced noise audio beam (704). With the signal levels normalized, the system 300 calculates an activation threshold to identify which audio beams include a speech component (706). In some implementations, the activation threshold is based on a sensitivity parameter (708). For example, the system 300 may calculate an activation threshold based on equation (1) above.

With the normalized signal levels, the system 300 compares each normalized signal level to the activation threshold (710). If gain generation is not based on whether a reduced noise audio beam recently included a speech component, block 712 may be skipped. However, if gain generation is based on whether a reduced noise audio beam recently included a speech component, the system 300 updates one or more counters based on the comparison of the normalized signal level to the activation threshold (712).

The system 300 generates the gain for each audio beam (714). For example, if block 712 is performed, the system 300 generates a gain as a constant value of the current gain in the current frame if the counter for the audio beam is at zero and the normalized signal level for the audio beam is less than the activation threshold. If the counter for the audio beam is at zero and the normalized signal level for the audio beam is less than the activation threshold, the system 300 fades the gain from a current value towards zero in the frame. If the normalized signal level for the audio beam is greater than the activation threshold, the system 300 fades the gain from a current value towards one in the frame.

If block 712 is not performed, the system 300 fades the gain from a current value towards zero in the frame if the normalized signal level is less than the activation threshold. If the normalized signal level is greater than the activation threshold, the system 300 fades the gain from the current value towards one in the frame. Fading the gain and preventing fading of the gain is described above with reference to FIG. 2.

To note, operation 700 is with reference to the signal characteristic including a signal level. Operation 700 may also be performed with reference to the signal characteristic including an SNR, such as described above with reference to FIG. 2.

Referring back to block 416 of the example operation in FIG. 4, determining which beams include a speech component is referred to herein as beam selection, which may also be referred to as determining which beams are active.

While not depicted in the example operation 400 in FIG. 4, other operations that may be performed by an audio mixing system (such as an audio mixing system 200 in FIG. 2 implemented in system 300 in FIG. 3) include pre-processing the audio signals from a microphone array, generating the audio beams from the audio signals by a beamformer (such as a fixed beamformer), mixing the audio beams by a mixer, and post-processing the mixed audio beam to generate the output beam for playback.

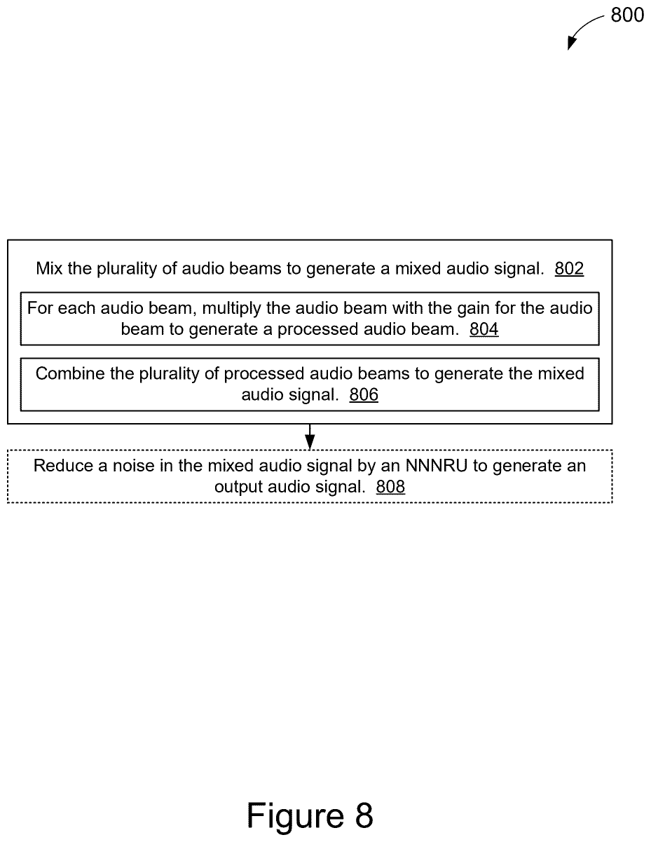

Referring to mixing and post-processing, after the gains are generated for the audio beams (such as the system 300 in FIG. 3 performing operation 400 in FIG. 4 to generate the gains), the system 300 mixes the audio beams using the generated gains. The system 300 may also post-process the mixed audio signal. An example implementation of mixing the audio beams and optionally post-processing (and in particular, performing noise reduction on) the mixed audio signal is depicted in FIG. 8.

FIG. 8 shows an illustrative flowchart depicting an example operation 800 for mixing the audio beams and generating an output audio signal, according to some implementations. The example operation 800 may be performed in addition to the example operation 400 in FIG. 4. In some implementations, the example operation 800 may be performed by an audio mixing system, such as the audio mixing system 200 in FIG. 2 that may be implemented in the system 300 in FIG. 3. As such, operation 800 is described below with reference to the system 300 in FIG. 3 performing the functions of the operation 800.

System 300 mixes the plurality of audio beams to generate a mixed audio signal (802). To mix the plurality of audio beams, the system 300 multiplies, for each audio beam, the audio beam with the gain for the audio beam to generate a processed audio beam (804). The system 300 then combines the plurality of processed audio beams to generate the mixed audio signal (806). For example, the system 300 adds the processed audio beams to generate the mixed audio signal.

In some implementations, the mixed audio signal is the output signal for playback by an audio device. In some other implementations, the system 300 reduces a noise in the mixed audio signal by an NNNRU to generate an output audio signal (808). For example, the audio signal post-processing 226 may apply an NNNRU to the mixed audio signal 224 to generate the output signal 228 for playback by an audio device (such as described above with reference to FIG. 2).

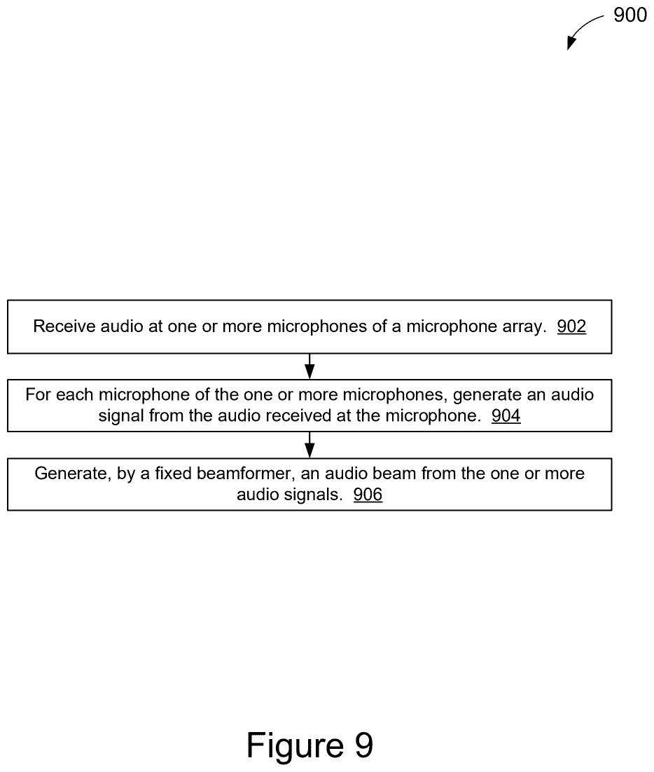

In some implementations, in addition to generating gains, mixing audio beams, and generating the output audio signal, the system 300 may include or be coupled to a microphone array and may include a fixed beamformer to generate audio signals and generate beams from the audio signals. An example implementation of generating the audio signals and the audio beams from the audio signals is depicted in FIG. 9.

FIG. 9 shows an illustrative flowchart depicting an example operation 900 for generating an audio beam, according to some implementations. The example operation 900 may be performed in addition to the example operation 400 in FIG. 4. In some implementations, the example operation 900 may be performed by an audio mixing system, such as the audio mixing system 200 in FIG. 2 that may be implemented in the system 300 in FIG. 3. As such, operation 900 is described below with reference to the system 300 in FIG. 3 performing the functions of the operation 900. In addition, the example operation 900 is depicted for generating a single audio beam, and operation 900 may be performed a plurality of times to generate all of the audio beams.

The system 300 receives audio at one or more microphones of a microphone array (902). For example, the microphones of the microphone array 202 receive audio from an environment including the microphone array 202. For each microphone of the one or more microphones, the system 300 generates an audio signal from the audio received at the microphone (904). For example, the microphone array 202 generates the audio signals 204 from the audio received at the microphones of the microphone array 202. The system 300 generates, by a fixed beamformer, an audio beam from the one or more audio signals (906). For example, the fixed beamformer 208 provides each audio signal 204 to an FIR filter and combines the outputs of the FIR filters to generate an audio beam 211. As described above, the audio beams are provided for mixing and for generating the gains to be used for mixing.

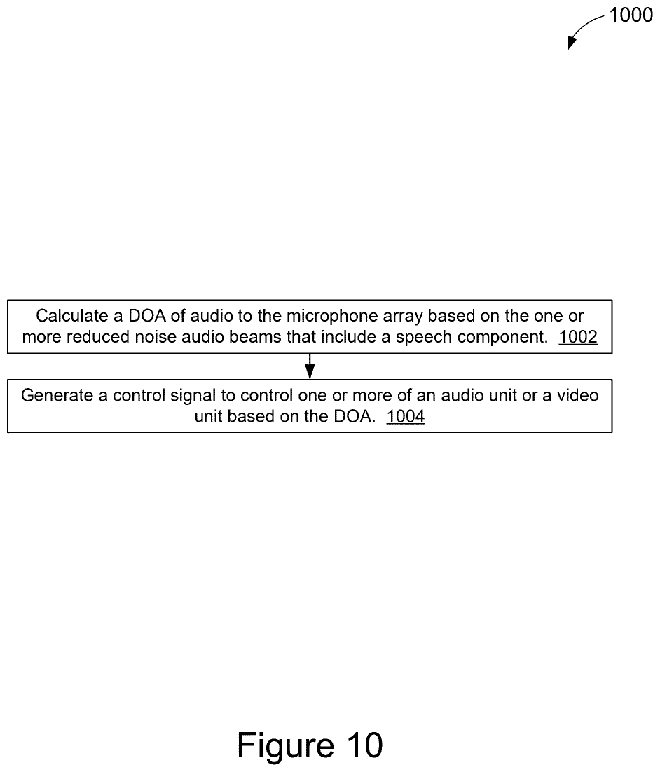

Referring back to the example operation 400 in FIG. 4 and the example operation 800 in FIG. 8, in addition to generating gains, mixing audio beams based on the gains, and generating the output audio signal as depicted, the system 300 may generate a control signal to control one or more of an audio device or a video device based on the beams selected by the System 300 in generating the gains. An example implementation of generating the control signal is depicted in FIG. 10.

FIG. 10 shows an illustrative flowchart depicting an example operation 1000 for generating a control signal based on a direction of arrival (DOA), according to some implementations. The example operation 1000 may be performed in addition to the example operation 400 in FIG. 4. In some implementations, the example operation 1000 may be performed by an audio mixing system, such as the audio mixing system 200 in FIG. 2 that may be implemented in the system 300 in FIG. 3. As such, operation 1000 is described below with reference to the system 300 in FIG. 3 performing the functions of the operation 900.

The system 300 calculates a DOA of audio to the microphone array based on the one or more reduced noise audio beams that include a speech component (1002). For example, the DOA logic 230 identifies a known DOA based on a selected beam indicated by active beam indicator 234. If more than one beam is selected, the DOA logic 230 may calculate an average DOA from the known DOAs of the plurality of beams selected. The system 300 generates a control signal to control one or more of an audio unit or a video unit based on the DOA (1004). As described above with reference to FIG. 2, the control signal may be in a format defined for the audio unit or the video unit and provided via an interface (such as an API for the audio unit or the video unit).

As described above, an audio mixing system is capable of generating a noise-reduced mixed audio signal with reduced beam selection lag that is faster than typical audio mixing solutions and denoises better than typical audio mixing solutions.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the disclosure.

The methods, sequences or algorithms described in connection with the aspects disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor.

In the foregoing specification, embodiments have been described with reference to specific examples thereof. It will, however, be evident that various modifications and changes may be made thereto without departing from the broader scope of the disclosure as set forth in the appended claims. The specification and drawings are, accordingly, to be regarded in an illustrative sense rather than a restrictive sense.

What is claimed is:

1. A method of audio mixing, comprising:
receiving a plurality of audio beams, wherein the audio beams are generated from a plurality of audio signals from a microphone array;
for each audio beam of the plurality of audio beams:
generating a reduced noise audio beam from the audio beam by reducing a noise component of the audio beam; and
calculating a signal characteristic of the reduced noise audio beam;
determining, based on the plurality of signal characteristics of the plurality of reduced noise audio beams, one or more reduced noise audio beams of the plurality of reduced noise audio beams that include a speech component; and
for each audio beam of the plurality of audio beams, generating a gain for the audio beam based on the determination.

2. The method of claim 1, further comprising:
for each reduced noise audio beam of the plurality of reduced noise audio beams, generating a time measurement based on when the reduced noise audio beam includes the speech component, wherein generating the gain for the audio beam corresponding to the reduced noise audio beam is further based on the time measurement.

3. The method of claim 2, wherein:
generating a time measurement for the reduced noise audio beam includes counting by a counter a number of frames of the reduced noise audio beam that includes the speech component, wherein the counting includes:
incrementing the counter by one or more in response to determining that the reduced noise audio beam includes the speech component in a current frame of the reduced noise audio beam; and
decrementing the counter by one or more in response to determining that the reduced noise audio beam does not include the speech component in the current frame of the reduced noise audio beam; and
generating the gain for the audio beam corresponding to the reduced noise audio beam includes reducing the gain towards zero based on the counter being at zero.

4. The method of claim 1, wherein for each reduced noise audio beam of the plurality of reduced noise audio beams, the signal characteristic of the reduced noise audio beam includes one of:
a signal level, wherein the signal level indicates an instantaneous signal power of the reduced noise audio beam; or
a signal-to-noise ratio (SNR), wherein the SNR indicates a ratio between the signal level of the reduced noise audio beam and a noise level of the noise component of the audio beam corresponding to the reduced noise audio beam.

5. The method of claim 4, wherein for each reduced noise audio beam of the plurality of reduced noise audio beams, calculating the SNR of the reduced noise audio beam includes:
calculating a first signal level of the audio beam corresponding to the reduced noise audio beam;
calculating a second signal level of the reduced noise audio beam;
calculating the noise level as a difference between the first signal level and the second signal level; and
calculating a ratio of the second signal level to the noise level as the SNR.

6. The method of claim 1, wherein for each audio beam of the plurality of audio beams, reducing the noise component of the audio beam includes:
inputting the audio beam to a neural network noise reduction unit (NNNRU) dedicated to processing the audio beam, wherein the NNNRU includes a recurrent neural network configured to receive samples of the audio beam based on a frequency spectrum of the audio beam; and
denoising the audio beam to generate the reduced noise audio beam by the NNNRU.

7. The method of claim 1, further comprising:
calculating a direction of arrival (DOA) of audio to the microphone array based on the one or more reduced noise audio beams that include the speech component; and
generating a control signal to control one or more of an audio unit or a video unit based on the DOA.

8. The method of claim 1, further comprising mixing the plurality of audio beams to generate a mixed audio signal, wherein mixing the plurality of audio beams includes:
for each audio beam of the plurality of audio beams, multiplying the audio beam with the gain for the audio beam to generate a processed audio beam; and
combining the plurality of processed audio beams to generate the mixed audio signal.

9. The method of claim 8, further comprising reducing a noise in the mixed audio signal by a neural network noise reduction unit (NNNRU) to generate an output audio signal.

10. The method of claim 8, further comprising:
for each audio beam of the plurality of audio beams:
receiving audio at one or more microphones of the microphone array;
for each microphone of the one or more microphones, generating an audio signal from the audio received at the microphone, wherein the plurality of audio signals includes the audio signal; and
generating, by a fixed beamformer, the audio beam from the one or more audio signals.

11. An audio mixing system comprising:
a processing system; and
a memory storing instructions that, when executed by the processing system, causes the audio mixing system to perform operations comprising:
receiving a plurality of audio beams, wherein the audio beams are generated from a plurality of audio signals from a microphone array;
for each audio beam of the plurality of audio beams:
generating a reduced noise audio beam from the audio beam by reducing a noise component of the audio beam; and
calculating a signal characteristic of the reduced noise audio beam;
determining, based on the plurality of signal characteristics of the plurality of reduced noise audio beams, one or more noise reduced audio beams of the plurality of reduced noise audio beams that include a speech component; and
for each audio beam of the plurality of audio beams, generating a gain for the audio beam based on the determination.

12. The audio mixing system of claim 11, wherein the operations further comprise:
for each reduced noise audio beam of the plurality of reduced noise audio beams, generating a time measurement based on when the reduced noise audio beam includes the speech component, wherein generating the gain for the audio beam corresponding to the reduced noise audio beam is further based on the time measurement.

13. The audio mixing system of claim 12, wherein:
generating a time measurement for the reduced noise audio beam includes counting by a counter a number of frames of the reduced noise audio beam that includes the speech component, wherein the counting includes:
incrementing the counter by one or more in response to determining that the reduced noise audio beam includes the speech component in a current frame of the reduced noise audio beam; and
decrementing the counter by one or more in response to determining that the reduced noise audio beam does not include the speech component in the current frame of the reduced noise audio beam; and
generating the gain for the audio beam corresponding to the reduced noise audio beam includes reducing the gain towards zero based on the counter being at zero.

14. The audio mixing system of claim 11, wherein for each reduced noise audio beam of the plurality of reduced noise audio beams, the signal characteristic of the reduced noise audio beam includes one of:
a signal level, wherein the signal level indicates an instantaneous signal power of the reduced noise audio beam; or
a signal-to-noise ratio (SNR), wherein the SNR indicates a ratio between the signal level of the reduced noise audio beam and a noise level of the noise component of the audio beam corresponding to the reduced noise audio beam.

15. The audio mixing system of claim 14, wherein for each reduced noise audio beam of the plurality of reduced noise audio beams, calculating the SNR of the reduced noise audio beam includes:
calculating a first signal level of the audio beam corresponding to the reduced noise audio beam;
calculating a second signal level of the reduced noise audio beam;
calculating the noise level as a difference between the first signal level and the second signal level; and
calculating a ratio of the second signal level to the noise level as the SNR.

16. The audio mixing system of claim 11, wherein for each audio beam of the plurality of audio beams, reducing the noise component of the audio beam includes:
inputting the audio beam to a neural network noise reduction unit (NNNRU) dedicated to processing the audio beam, wherein the NNNRU includes a recurrent neural network configured to receive samples of the audio beam based on a frequency spectrum of the audio beam; and
denoising the audio beam to generate the reduced noise audio beam by the NNNRU.

17. The audio mixing system of claim 11, wherein the operations further comprise:
calculating a direction of arrival (DOA) of audio to the microphone array based on the one or more reduced noise audio beams that include the speech component; and
generating a control signal to control one or more of an audio unit or a video unit based on the DOA.

18. The audio mixing system of claim 11, wherein the operations further comprise mixing the plurality of audio beams to generate a mixed audio signal, wherein mixing the plurality of audio beams includes:
for each audio beam of the plurality of audio beams, multiplying the audio beam with the gain for the audio beam to generate a processed audio beam; and
combining the plurality of processed audio beams to generate the mixed audio signal.

19. The audio mixing system of claim 18, wherein the operations further comprise reducing a noise in the mixed audio signal by a neural network noise reduction unit (NNNRU) to generate an output audio signal.

20. The audio mixing system of claim 18, further comprising the microphone array, wherein the operations further comprise:
receiving audio at one or more microphones of the microphone array;
for each microphone of the one or more microphones, generating an audio signal from the audio received at the microphone, wherein the plurality of audio signals includes the audio signal; and
generating, by a fixed beamformer, the audio beam from the one or more audio signals.
